(19) United States
(12) Patent Application Publication
(10) Pub. No.: US 2025/0141810 A1
(43) Pub. Date: May 1, 2025

(54) ETHERNET DATA PACKET CAPTURE AND FORMAT TO PCAP STRUCTURE AT RADIO UNIT

(71) Applicant: Rakuten Symphony, Inc., Tokyo (JP)

(72) Inventors: Abhay KUMAR, Bangalore (IN); Stuti SINHA, Bangalore (IN)

(73) Assignee: Rakuten Symphony, Inc., Tokyo (JP)

(21) Appl. No.: 18/607,781

(22) Filed: Mar. 18, 2024

(30) Foreign Application Priority Data
Oct. 30, 2023 (IN) 202341073775

(51) Int. Cl. H04L 47/36; H04L 47/28; H04L 69/22

(52) U.S. Cl. CPC H04L 47/36; H04L 47/28; H04L 69/22

(57) ABSTRACT

Embodiments of the present disclosure disclose a Radio Unit (RU) comprising a Double Data Rate (DDR) memory unit, a control unit and a Programmable Logic (PL) unit. The PL unit is configured to capture plurality of data packets exchanged between RU and a Distributed Unit (DU) and determine a timestamp and a data size of the captured data packets. Further, the PL unit generates a data packet header comprising timestamp and data size information of the data packets and appends the header to the data packets before transmitting the data packets for storing in DDR memory unit. Thereafter, the control unit retrieves the data packets from the DDR memory unit and generates a Packet Capture (PCAP) data file, which may be used for validating the data packets exchanged between the RU and the DU, without the need of an external logic analyzer.

### CROSS REFERENCE TO RELATED APPLICATION(S)

This application claims priority based on India patent application No. 202341073775 filed Oct. 30, 2023.

### TECHNICAL FIELD

The present disclosure generally relates to ethernet data packet capture and format to Packet Capture (PCAP) structure at a Radio Unit (RU) in a 5G Radio Access Network (RAN) architecture.

### BACKGROUND

In a 5G Radio Access Network (RAN) network architecture, a Radio Unit (RU) is connected to a Distributed Unit (DU) to provide support for lower layers of the RAN protocol stack such as Radio Link Control (RLC), Media Access Control (MAC) and Physical layer. To analyze data packets exchanged between the RU and the DU, or to check if an intended data packet is successfully sent or received or dropped in between, the data packets sent/received to/from the RU/DU need to be captured. For example, when the RU transmits data packets to the DU, it is essential to know the contents of the data packets, and whether all the intended data packets have reached the DU or not, to control subsequent data transmission.

In the existing RUs, a Field Programmable Gate Array (FPGA), having limited storage resources, is used to track and process the data packets received from the DU. A logic configured on the FPGA can determine whether the data packet is received or not using statistics and counter information. However, the existing FPGAs do not support capturing the data packets to view and further analyze the contents of the data packets due to limited memory resources in the RU. Consequently, the existing FPGAs are configured to use an external Logic Analyzer to capture the data packets. However, in order to use the Logic Analyzer to capture and analyze the data packets, the data packets need to be downloaded from the FPGA to a system hosting the Logic Analyzer, using a cable connecting the RU and the system. Thus, it becomes extremely difficult to capture and analyze large data packets on the existing FPGAs. As a result, it becomes difficult to validate whether correct and complete set of data packets are received in the right order. Therefore, viewing and analyzing the data packets from the existing FPGAs is tedious and time consuming.

The information disclosed in this background of the disclosure section is only for enhancement of understanding of the general background of the disclosure and may not be taken as an acknowledgement or any form of suggestion that this information forms the prior art already known to a person skilled in the art.

### BRIEF SUMMARY

In an embodiment, the present disclosure discloses a Radio Unit (RU). The RU comprises a Double Data Rate (DDR) memory unit, a control unit, and a Programmable Logic (PL) unit. The control unit is communicatively coupled with the DDR memory unit and is configured to reserve a memory region of predefined size on the DDR memory unit to store a plurality of data packets exchanged between the RU and a Distributed Unit (DU) connected to the RU. The PL unit is configured to capture each of the plurality of data packets exchanged between the RU and the DU upon receiving a trigger command from the control unit. Further, the PL unit is configured to determine a timestamp and a data size of each of the plurality of data packets. Furthermore, the PL unit is configured to generate a data packet header corresponding to each of the plurality of data packets. The data packet header comprises the timestamp and the data size of each of the plurality of data packets. Subsequently, the PL unit is configured to append the data packet header to each of the plurality of data packets and transmit each of the plurality of data packets to store in the DDR memory unit. Thereafter, the control unit is configured to retrieve each of the plurality of data packets stored in the DDR memory unit according to the timestamp and the data size of each of the plurality of data packets. Further, the control unit is configured to generate a Packet Capture (PCAP) data file by converting each of the plurality of data packets into a PCAP format to validate the plurality of data packets exchanged between the RU and the DU.

In another embodiment, the present disclosure discloses a method for capturing each of a plurality of data packets exchanged between a Radio Unit (RU) and a Distributed Unit (DU) connected to the RU, upon receiving a trigger command from a control unit of the RU. Further, the method comprises determining a timestamp and a data size of each of the plurality of data packets. Furthermore, the method comprises generating a data packet header corresponding to each of the plurality of data packets, wherein the data packet header comprises the timestamp and the data size of each of the plurality of data packets. Thereafter, the method comprises appending the data packet header to each of the plurality of data packets. Subsequently, the method comprises transmitting each of the plurality of data packets, appended with the data packet header, to a Double Data Rate (DDR) memory unit of the RU. Finally, the method comprises generating a Packet Capture (PCAP) data file corresponding to the plurality of data packets by converting each of the plurality of data packets into a PCAP format for validating the plurality of data packets exchanged between the RU and the DU.

In yet another embodiment, the present disclosure discloses a non-transitory computer readable storage medium including instructions stored thereon, that when processed by at least one processor, cause a Programmable Logic (PL) unit of a Radio Unit (RU) to perform operations comprising capturing each of a plurality of data packets exchanged between the RU and a Distributed Unit (DU) connected to the RU, upon receiving a trigger command from a control unit of the RU. Further, instructions cause the PL unit to determine a timestamp and a data size of each of the plurality of data packets. Furthermore, the instructions cause the PL to generate a data packet header corresponding to each of the plurality of data packet. The data packet header comprises the timestamp and the data size of each of the plurality of data packets; Subsequently, the instructions cause the PL to append the data packet header to each of the plurality of data packets. Thereafter, the instructions cause the PL to transmit each of the plurality of data packets, appended with the data packet header, to a Double Data Rate (DDR) memory unit of the RU. Finally, the instructions cause generating a Packet Capture (PCAP) data file corresponding to the plurality of data packets by converting each of the plurality of data packets into a PCAP format for validating the plurality of data packets exchanged between the RU and the DU.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of at least one of device and methods in accordance with embodiments of the present subject matter are now described, by way of example only, and with reference to the accompanying figures, in which:

FIG. 1 shows an exemplary schematic representation of a 5G Radio Access Network (RAN) architecture, where some embodiments of the present disclosure may be implemented;

FIG. 2 shows a detailed block diagram of the RU of FIG. 1 in accordance with some embodiments of the present disclosure;

FIGS. 3A and 3B show flowcharts collectively illustrating a method of generating Packet Capture (PCAP) data file corresponding to the plurality of data packets received or transmitted by the RU in accordance with some embodiments of the present disclosure; and

FIG. 4 shows a flowchart illustrating a method of merging uplink data packets and downlink data packets for generating the PCAP data file in accordance with some embodiments of the present disclosure.

It may be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It can be understood, however that it is not intended to limit the disclosure to the particular forms disclosed, but on the contrary, the disclosure is to cover a plurality of modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It may be noted that, for convenience of explanation, the disclosure uses terms and names defined in the 3rd Generation Partnership Project Radio Access Network (3GPP RAN) standards. More specifically, the terms ‘service-based architecture’, ‘frequency band combination’, ‘carrier aggregation’, ‘idle mode cell reselection’, ‘frequency measurements’ ‘RRCConnectionRelease message’, ‘secondary cell addition’, ‘secondary node addition’, ‘handover’ and the like are to be interpreted as specified by the 3GPP RAN standards.

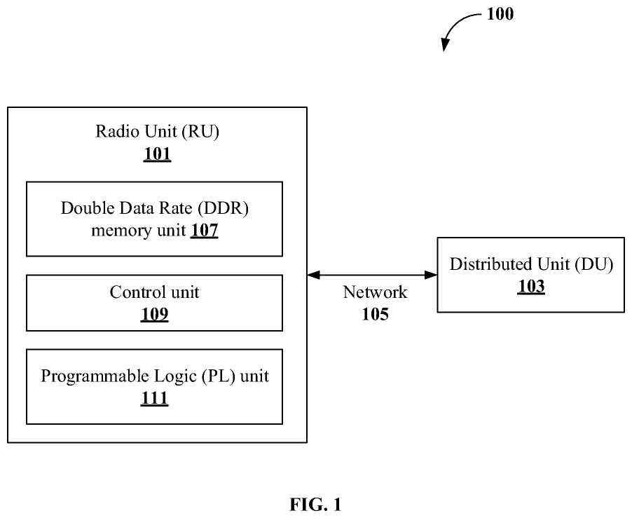

FIG. 1 shows an exemplary schematic representation of a 5G Radio Access Network (RAN) architecture 100, where some embodiments of the present disclosure may be implemented. In an embodiment, the architecture 100 may comprise, without limiting to, a Radio Unit (RU) 101, and a Distributed Unit (DU) 103 which are communicatively coupled via a network 105. In an embodiment, the RU 101 may be a network component deployed on top of a base station (not shown in FIG. 1) and configured to emit Radio Frequency (RF) signals, thereby facilitating one or more end-user equipment (not shown in FIG. 1) to connect to the 5G network. In an embodiment, the DU 103 may be a component of the base station (alternatively referred to as gNB or gNodeB). The DU 103 may be configured to perform operations comprising, without limiting to, providing support for lower layers of the 5G protocol stack such as Radio Link Control (RLC), Media Access Control (MAC) and Physical layer. In an embodiment, the network 105 may include, without limiting to, a 10 Gigabits or 25 Gigabits ethernet channel (i.e., 10G/25G link) that connects the RU 101 and the DU 103 and facilitates exchange of data packets between the RU 101 and the DU 103. It shall be noted that the 5G RAN architecture 100 depicted in FIG. 1 has been simplified for the sake of explanation of the present disclosure. In various other implementations, the 5G RAN architecture may comprise one or more additional components and services.

In an implementation, the RU 101 may comprise, without limiting to, a Double Data Rate (DDR) memory unit 107, a control unit 109 and a Programmable Logic (PL) unit 111. In an embodiment, the DDR memory unit 107 may be configured to store control and operational logic and related data required for the functioning of the RU 101. As an example, memory size of the DDR memory unit 107 may be 2 Gigabytes. In a non-limiting embodiment, the size of the DDR memory unit 107 may be varied according to network requirements. In an embodiment, the control unit 109 may be a processor that is configured to control and manage overall operations of the RU 101 and ensure synchronization of operations of the DDR memory unit 107 and the PL unit 111. In an embodiment, the PL unit 111 may be a Field Programmable Gate Array (FPGA) integrated circuit, which is configured to perform various functions of the RU 101 based on the control and operational logic stored in the DDR memory unit 107. As an example, some of the functions performed by the PL unit 111 may include, without limiting to, transfer of data packet from/to the RU 101 to/from the DU 103, achieving a synchronization with the DDR memory unit 107, and providing a support for multiple air interfaces, and high-performance Radio Frequency (RF) transceiver portfolios.

In an embodiment, in addition to the above-mentioned functions, the PL unit 111 may also be configured to capture and analyze the data packets that are being exchanged between the RU 101 and DU 103. As an example, capturing and analyzing the data packets may be necessary to understand what data is being exchanged between the RU 101 and the DU 103 and whether all of the intended data packets are being exchanged in the required order of transmission.

In an embodiment, a portion of the DDR memory unit 107 is reserved for the PL unit 111, such that the PL unit 111 may use the reserved memory space for capturing and analyzing the data packets exchanged between the RU 101 and the DU 103. Since the PL unit 111 is provided with adequate memory space, the PL unit 111 may now be able to capture even the large data packets and analyze them locally on the RU 101. As a result, the PL unit 111 may perform accurate validation of the data packets by determining whether correct set of data packets are received/transmitted and whether the data packets are received/transmitted in the right order. The accuracy of validation is enhanced since the PL unit 111 has access to the captured data packets and can analyze the data packets based on the contents of the data packets, in addition to the statistics and counter information of the data packets. Moreover, the proposed RU 101 configuration also helps in faster analysis or validation of the data packets, since the requirement of using the external logic analyzer, which is tedious and time consuming, is removed.

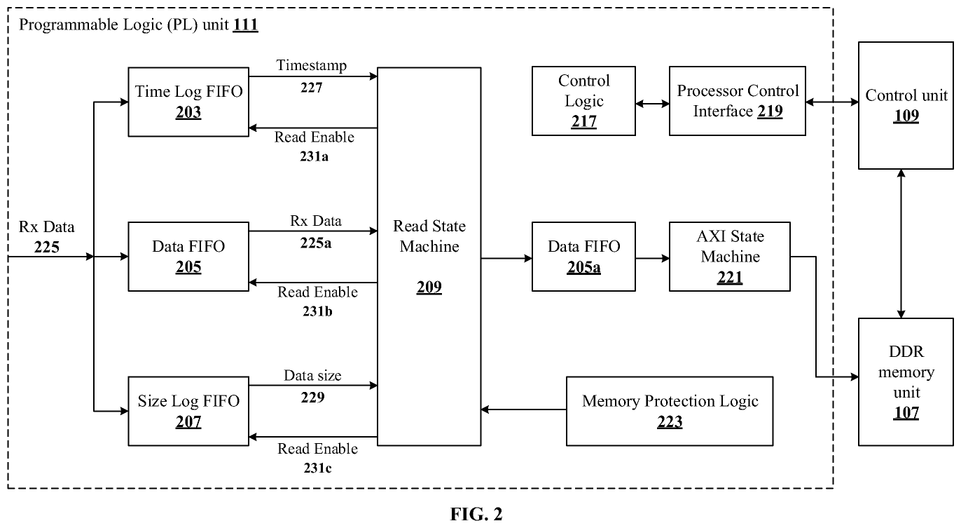

FIG. 2 shows a detailed block diagram of the RU 101 in accordance with some embodiments of the present disclosure. In an embodiment, as shown in FIG. 1, the RU 101 may comprise, without limiting to, the Programmable Logic (PL) unit 111, the Double Data Rate (DDR) memory unit 107 and the control unit 109, which are connected to each other using a suitable connection interface. In an embodiment, the PL unit 111 may be configured with a plurality of First-In-First-Out (FIFO) arrays, such as a Time Log FIFO 203, a Data FIFO 205, 205a and a Size Log FIFO 207. Additionally, the PL unit 111 may be configured with a read state machine 209, a control logic 217, a processor control interface 219, an Advanced extensible Interface (AXI) state machine 221, and a memory protection logic 223. It shall be noted that the configuration of the PL unit 111 as shown in FIG. 2 is only for the sake of explanation and the PL unit 111 may comprise one or more other components than the components shown in FIG. 2 in an actual implementation scenario.

For the sake of explanation, the operations of the PL unit 111 are explained with reference to the data packets, i.e., Rx Data 225, that are received at the RU 101. Similarly, the operations of the PL unit 111 may also be explained with reference to the data packet, i.e., Tx Data, transmitted from the RU 101 to the DU 103. In an embodiment, the Time Log FIFO 203 may be used to store a timestamp 227 information of each of the plurality of data packets in the Rx Data 225. The Data FIFO 205 may be used to store the contents of each of the plurality of data packets in the Rx Data 225. The Size Log FIFO 207 may be used to store data size 229 information of each of the plurality of data packets in the Rx Data 225. In an implementation, the PL unit 111 may be configured to capture all the packets transmitted/received by the RU 101. The PL unit 111 may initiate capturing of the data packets upon receiving an input signal or a trigger command from the control unit 109. As an example, the trigger command may indicate how many data packets or data frames need to be captured. Once the trigger command is received, the PL unit 111 may wait for a 10 ms frame boundary to start capturing the data packets. In an embodiment, each captured data packet is timestamped, and the data size 229 of each packet is recorded. The timestamp 227 and data size 229 information of each packet are then stored temporarily on the Time Log FIFO 203 and the Size Log FIFO 207 respectively.

In an embodiment, the read state machine 209 may be configured to retrieve the timestamp 227, the data contents and the data size 229 information of each data packet from the Time Log FIFO 203, the Data FIFO 205 and the Size Log FIFO 207 respectively, when the respective ‘read enable’ flags, i.e., read enable 231a, read enable 231b and read enable 231c, are set. When Size Log FIFO 207 is not empty, the ‘read enable’ flag is set ‘high’ to retrieve the data. Subsequently, the read state machine 209 may generate a data packet header from the timestamp 227 and the data size 229 information of each data packet and pre-pend the data packet header to the respective data packets, along with the contents of the data packets.

In an embodiment, after pre-pending the data packets with the respective data packet headers, all the data packets may be aligned to a predefined packet size. For example, the predefined packet size may be aligned to a 16-byte boundary. This means that the overall size of the data packet must be in multiples of 16 bytes. For example, a 60-byte data packet may be allocated a 64-byte memory region (i.e., 4*16-byte). Since the last 4-bytes on the reserved memory region are uninitialized, the read state machine 209 may append the uninitialized bytes with ‘0’ bits or any other random data bit values to align the overall packet size to the allocated memory region of 64-bytes.

In an embodiment, out of the allocated 64-bytes, 4-byte (or 24-bits) region is reserved for the Size_Log information of the data packets. The Size_Log information indicates the total number of samples (in 16-bits), along with the number of valid bytes (in 8-bits) in the last sample of the allocated memory region. In the above example, since there are 4 samples (i.e., 0x0004), and the number of valid bytes in the last sample is 12 (i.e., 0x0C), the Size_Log may indicate 0x0C0004.

Further, 80-bits of the allocated 64-bytes may be reserved to indicate Time_Log information related to the data packets. As an example, the Time_Log information contains Time of Day (TOD) of transmitting/receiving the data packets. Within the Time_Log information, 48-bits are used for storing the ‘second’ field of the TOD and 32-bits are used for storing the ‘nano-second’ field of the TOD. In an embodiment, the data packet header may take up 128-bits (i.e., x″00″ & Size_Log & x″0000″ & Time_Log) and is used to indicate the timestamp 227 and the data size 229 information of the data packets. The remaining space of the allocated 64-bytes memory region may contain the actual data content of the data packets.

The data packets, updated with the header, are then moved to the Data FIFO 205a. Thereafter, the AXI state machine 221 may retrieve the data packets from the Data FIFO 205a and fragment the retrieved data packets into smaller fragments of Advanced extensible Interface (AXI) burst format for ‘writing’ the data packets to the DDR memory unit 107. As an example, the AXI state machine 221 may fragment the packets such that the data coming from data FIFO 205a is arranged into 8 samples of 128-bit smaller bursts. In an embodiment, fragmentation of the data packets into AXI bursts helps in faster and simultaneous transfer of multiple data packets into the DDR memory unit 107.

In an embodiment, a memory region of predefined size may be reserved on the DDR memory unit 107 for storing the data packets being ‘written’ by the AXI state machine 221. In an implementation, the size of the reserved memory region may be 64 MB for storing the data packets received at the RU 101 (i.e., Rx Data) and 64 MB for storing the data packets transmitted by the RU 101 (i.e., Tx Data). The size of the reserved memory region on the DDR memory unit 107 may be dynamically configurable (i.e., increased or decreased) based on requirements, bandwidth of the network 105 connecting the RU 101 and the DU 103, and the total size of the DDR memory unit 107.

In an embodiment, the memory protection logic 223 may be configured to monitor the packet size of each of the plurality of data packets to prevent an overflow of the data packets while ‘writing’ the data packets to the DDR memory unit 107. As an example, the memory protection logic 223 may monitor the packet size and calculate a last byte address of the data packets. When the data packet is about to cross a predefined memory region, which is, for example 64 MB, the memory protection logic 223 instructs the AXI state machine 221 to drop the data packet and conclude the on-going ‘write’ operation.

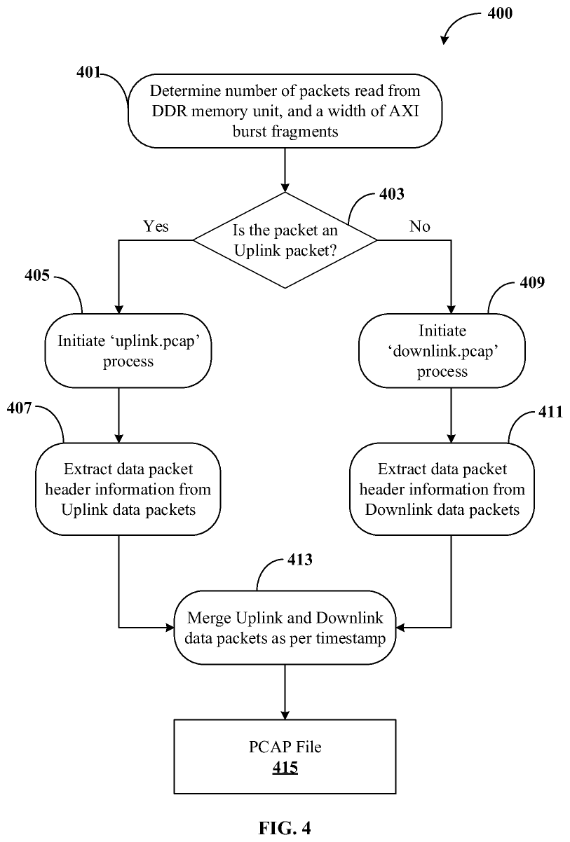

In an embodiment, the control unit 109 may monitor and control the operations of the read state machine 209, the AXI state machine 221 and the memory protection logic 223 using a control logic 217, through a preconfigured processor control interface 219 of the PL unit 111. After detecting completion of ‘writing’ of all the data packets to the DDR memory unit 107, the control unit 109 may ‘read’ the data packets stored in the DDR memory unit 107. For example, the control unit 109 may ‘read’ the data packets from the ‘DDR_First_Address’, which indicates the first byte address of the DDR memory unit 107, from where the ‘write’ operation was started. Further, the control unit 109 may extract each data packet from the DDR memory unit 107 in the order of the data size 229 or ‘Size_Log’ information associated with each data packet. In an embodiment, the control unit 109 may read and extract the transmitted/received data packets (i.e., Tx Data and Rx Data) separately from the DDR memory unit 107, and merge them for generating PCAP file, by performing a method illustrated in FIG. 4.

In an embodiment, the control unit 109 may control the ‘write’ operations of the data packets to the DDR memory unit 107 using a ‘storeEthDataDdr’ Application Programming Interface (API). The ‘storeEthDataDdr’ may be used to perform at least the following operations of the control unit 109:
Set ‘Capture_Duration’ flag—the ‘Capture_Duration’ indicates the captured duration in the unit of 10 ms. For example, all the data packets received for a duration of 1 second may be captured by 100 or 0x64 ‘write’ operations on the DDR memory unit 107.
Trigger the capture of data packets.
Read ‘Capture_Done’ flag—the ‘Capture_Done’ field indicates when the capture of all the data packets is completed.
Read ‘DDR_Total_Number_Of_Samples’ flag—It indicates total number of data samples written, where each sample is 128 bits.

In an embodiment, the control unit 109 may control the ‘read’ operations of the data packets from the DDR memory unit 107 using a ‘ReadEthDataDdr’ API. The ‘ReadEthDataDdr’ may be used to read the data packets stored in DDR memory unit 107 and then convert the read data packets into the PCAP format. Further, a PCAP file is generated from the data packets in the PCAP format.

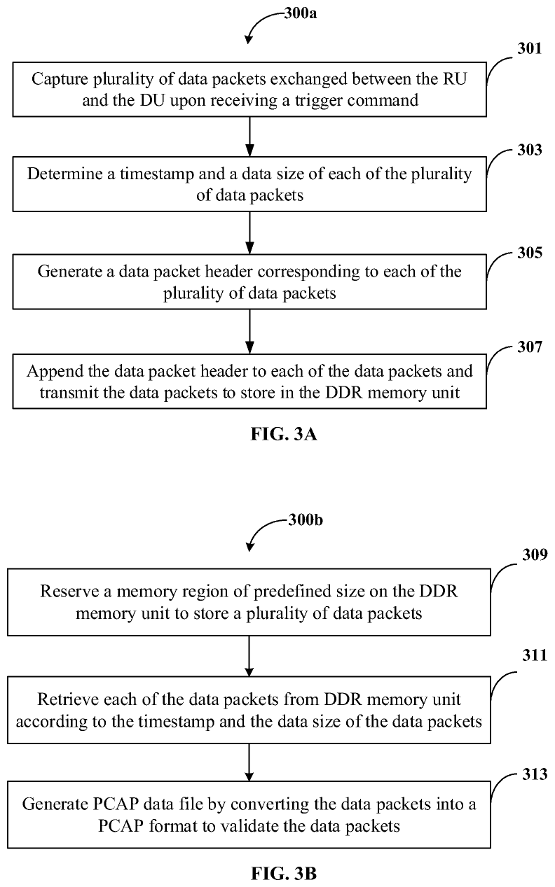

FIGS. 3A and 3B show flowcharts 300a and 300b, which collectively illustrate a method of generating Packet Capture (PCAP) data file corresponding to the plurality of data packets received or transmitted by a Radio Unit (RU) 101 in accordance with some embodiments of the present disclosure. As illustrated in FIG. 3A and FIG. 3B, the methods 300a and 300b may comprise one or more steps. The methods 300a and 300b may be described in the general context of computer executable instructions. Generally, computer executable instructions can include routines, programs, objects, components, data structures, procedures, modules, and functions, which perform particular functions or implement particular abstract data types. The order in which the methods 300a and 300b are described is not intended to be construed as a limitation, and any number of the described method blocks can be combined in any order to implement the method. Additionally, individual blocks may be deleted from methods 300a and 300b without departing from the scope of the subject matter described herein. Furthermore, methods 300a and 300b can be implemented in any suitable hardware, software, firmware, or combination thereof.

At block 301, the Programmable Logic (PL) unit 111 of the RU 101 may capture each of the plurality of data packets exchanged between the RU 101 and the Distributed Unit (DU) 103, connected to the RU 101, upon receiving a trigger command from the control unit 109 of the RU 101. In an embodiment, the plurality of data packets may include, without limiting to, one or more uplink data packets and one or more downlink data packets. The one or more uplink data packets may be stored in a first region of the DDR memory unit 107 in the RU 101. Similarly, the one or more downlink data packets may be stored in a second region of the DDR memory unit 107. Further, as an example, the trigger command received from the control unit 109 may comprise, without limiting to, at least one of a total number of the data packets to be captured by the PL unit 111, a capture duration and an indication to capture at least one of the downlink data packets and the uplink data packets.

At block 303, the PL unit 111 may determine the timestamp 227 and the data size 229 of each of the plurality of data packets. As an example, the timestamp 227 of a data packet may indicate the time at which the data packet was transmitted from the RU 101 or received at the RU 101. The data size 229 of the data packet may indicate a total size of the data packet. Both the timestamp 227 and the data size 229 may be used to analyze various parameters such as, without limiting to, bandwidth of the network 105 connecting the RU 101 and the DU 103, packet loss during transmission, transmission order of the data packets and the like.

At block 305, the PL unit 111 may generate a data packet header corresponding to each of the plurality of data packets. The data packet header may comprise, without limiting to, the timestamp 227 and the data size 229 of each of the plurality of data packets.

At block 307, the PL unit 111 may append the data packet header to each of the plurality of data packets and transmit each of the plurality of data packets to store in the DDR memory unit 107. In an embodiment, after appending the data packet header to each of the plurality of data packets, the PL unit 111 may compare the packet size of each of the plurality of data packets with a predefined packet size. Further, the PL unit 111 may identify one or more data packets, among the plurality of data packets, whose packet size is less than the predefined packet size. Thereafter, the PL unit 111 may append a plurality of random data bits to each of the one or more identified data packets to match the packet size of each of the one or more data packets with the predefined packet size.

In an embodiment, after appending the data packet header to each of the plurality of data packets, the PL unit 111 may fragment each of the plurality of data packets into a predefined number of Advanced extensible Interface (AXI) burst fragments and burst the AXI burst fragments into the DDR memory unit 107. In an embodiment, the PL unit 111 may be additionally configured to monitor a packet size of each of the plurality of data packets to prevent an overflow of the plurality of data packets while transmitting the plurality of data packets to the DDR memory unit 107.

FIG. 3B illustrates a method 300b performed by the control unit 109 of the RU 101 for validating the plurality of data packets exchanged between the RU 101 and the DU 103. At block 309, the control unit 109 may reserve a memory region of predefined size on the DDR memory unit 107 to store the plurality of data packets exchanged between the RU 101 and the DU 103. In an implementation, the predefined size of the memory region reserved on the DDR memory unit 107 may be determined based on bandwidth of a communication channel established between the RU 101 and the DU 103.

At block 311, the control unit 109 may retrieve each of the plurality of data packets stored in the DDR memory unit 107 by the PL unit 111. In an embodiment, the plurality of data packets may be retrieved according to the timestamp 227 and the data size 229 of each of the plurality of data packets.

Subsequently, at block 313, the control unit 109 may generate a Packet Capture (PCAP) data file by converting each of the plurality of data packets into a PCAP format to validate the plurality of data packets exchanged between the RU 101 and the DU 103. In an embodiment, the control unit 109 may generate the PCAP data file by merging each of the one or more uplink data packets and each of the one or more downlink data packets according to the timestamp 227 of each of the one or more uplink data packets and each of the one or more downlink data packets.

FIG. 4 shows a flowchart illustrating a method 400 of merging uplink data packets and downlink data packets for generating the PCAP data file in accordance with some embodiments of the present disclosure.

At block 401, the control unit 109 may determine a total number of data packets retrieved from the DDR memory unit 107. Also, the control unit 109 may determine a width of the AXI burst fragments corresponding to the retrieved data packets. Thereafter, the control unit 109 may determine, at block 403, whether the retrieved data packet is an uplink data packet or a downlink data packet. As an example, the decision on whether the data packet is the uplink data packet or the downlink data packet is made based on in which memory location the data packet is stored. There are separate memory locations for Uplink and Downlink packets.

In an embodiment, if it is determined that the data packet is an uplink data packet, the control unit 109 may initiate an uplink PCAP generation process using a ‘uplink.pcap’ function, as indicated in block 405. Thereafter, at block 407, the control unit 109 may extract the data packet header information from the uplink data packets and determine information such as timestamp 227 and data size 229 of the data packets.

In an embodiment, if it is determined that the data packet is a downlink data packet, the control unit 109 may initiate a downlink PCAP generation process using a ‘downlink.pcap’ function, as indicated in block 409. Thereafter, at block 411, the control unit 109 may extract the data packet header information from the downlink data packets and determine the timestamp 227 and the data size 229 of the data packets.

Subsequently, at block 413, the control unit 109 may merge each of the uplink data packets and the downlink data packets according to the timestamp 227 of each of the uplink data packets and the downlink data packets. As an example, after all the data packets are merged, the data packets may be in the sorted order of the timestamp 227 associated with the data packets. Subsequent to merging the data packets, the control unit 109 may generate the PCAP file 415 comprising both the uplink data packets and the downlink data packets.

In an embodiment, the ‘uplink.pcap’ function and the ‘downlink.pcap’ function may be interfaced with the ‘LibPcap’ library to generate the PCAP file 415. ‘LibPcap’ provides a portable framework for low-level network monitoring. Also, ‘Libpcap’ helps in network statistics collection, security monitoring and network debugging for the low-level network applications. Further, it shall be noted that converting the captured data packets into the industry standard PCAP format helps in easy view/analysis of the data packets, specifically in case of 5G RAN architecture.

Thus, the RU configuration proposed by the present disclosure aims to overcome one or more limitations of the existing RUs. For instance, the proposed RU configuration addresses the limitation of memory resource availability in the existing RUs, by allocating a DDR memory space of predefined size for capturing and analyzing the data packets. In other words, the proposed RU configuration ensures that there is sufficient memory available for capturing and processing even a large amount of data packets exchanged between the RU 101 and the DU 103. Also, the proposed RU configuration is designed to analyze the data packets by considering the content of the data packets, timestamp, and data size of the data packets, thereby ensuring accurate analysis of the data packets. To the contrary, the conventional RUs consider only the statistics and counter information of the data packets to analyze the data packets. Moreover, according to the proposed RU configuration, the captured data packets are converted into PCAP data format eventually converted into a PCAP file, which makes it easy and convenient to capture and analyze the data packets.

It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description.

We claim:

1. A Radio Unit (RU) comprising:
a Double Data Rate (DDR) memory unit;
a control unit, communicatively coupled with the DDR memory unit, and configured to reserve a memory region of predefined size on the DDR memory unit to store a plurality of data packets exchanged between the RU and a Distributed Unit (DU) connected to the RU; and
a Programmable Logic (PL) unit configured to:
capture each of the plurality of data packets exchanged between the RU and the DU upon receiving a trigger command from the control unit;
determine a timestamp and a data size of each of the plurality of data packets;
generate a data packet header corresponding to each of the plurality of data packets, wherein the data packet header comprises the timestamp and the data size of each of the plurality of data packets; and
append the data packet header to each of the plurality of data packets and transmit each of the plurality of data packets to store in the DDR memory unit,
wherein the control unit is further configured to:
retrieve each of the plurality of data packets stored in the DDR memory unit according to the timestamp and the data size of each of the plurality of data packets; and
generate a Packet Capture (PCAP) data file by converting each of the plurality of data packets into a PCAP format to validate the plurality of data packets exchanged between the RU and the DU.

2. The RU of claim 1, wherein the PL unit is further configured to:
compare a packet size of each of the plurality of data packets with a predefined packet size, after appending the data packet header to each of the plurality of data packets;
identify one or more data packets, among the plurality of data packets, whose packet size is less than the predefined packet size; and
append a plurality of random data bits to each of the one or more identified data packets to match the packet size of each of the one or more data packets with the predefined packet size.

3. The RU of claim 1, wherein the PL unit is further configured to:
monitor a packet size of each of the plurality of data packets to prevent an overflow of the plurality of data packets.

4. The RU of claim 1, wherein the PL unit is further configured to:
fragment, after appending the data packet header to each of the plurality of data packets, each of the plurality of data packets into a predefined number of Advanced extensible Interface (AXI) burst fragments; and
burst the AXI burst fragments into the DDR memory unit.

5. The RU of claim 1, wherein the predefined size of the memory region reserved on the DDR memory unit is determined based on bandwidth of a communication channel established between the RU and the DU.

6. The RU of claim 1, wherein the trigger command comprises at least one of a total number of data packets to be captured by the PL unit, a capture duration and an indication to capture at least one of downlink data packets and uplink data packets.

7. The RU of claim 1, wherein the plurality of data packets includes one or more uplink data packets and one or more downlink data packets, wherein the one or more uplink data packets are stored in a first region of the DDR memory unit, which is different from a second region of the DDR memory unit used to store the one or more downlink data packets.

8. The RU of claim 1, wherein the control unit generates the PCAP data file by merging each of the one or more uplink data packets and each of the one or more downlink data packets according to the timestamp of each of the one or more uplink data packets and each of the one or more downlink data packets.

9. A method comprising:
capturing, by a Programmable Logic (PL) unit configured in a Radio Unit (RU), each of a plurality of data packets exchanged between the RU and a Distributed Unit (DU) connected to the RU, upon receiving a trigger command from a control unit of the RU;
determining, by the PL, a timestamp and a data size of each of the plurality of data packets;
generating, by the PL, a data packet header corresponding to each of the plurality of data packets, wherein the data packet header comprises the timestamp and the data size of each of the plurality of data packets;
appending, by the PL, the data packet header to each of the plurality of data packets;
transmitting, by the PL, each of the plurality of data packets, appended with the data packet header, to a Double Data Rate (DDR) memory unit of the RU; and
generating, by the control unit, a Packet Capture (PCAP) data file corresponding to the plurality of data packets by converting each of the plurality of data packets into a PCAP format for validating the plurality of data packets exchanged between the RU and the DU.

10. The method of claim 9, further comprises reserving, by the control unit, a memory region of predefined size on the DDR memory unit to store the plurality of data packets exchanged between the RU and the DU.

11. The method of claim 9, further comprises:
comparing, by the PL unit, a packet size of each of the plurality of data packets with a predefined packet size, after appending the data packet header to each of the plurality of data packets;
identifying, by the PL unit, one or more data packets, among the plurality of data packets, whose packet size is less than the predefined packet size; and
appending, by the PL unit, a plurality of random data bits to each of the one or more identified data packets to match the packet size of each of the one or more data packets with the predefined packet size.

12. The method of claim 9, further comprises monitoring, by the PL unit, a packet size of each of the plurality of data packets to prevent an overflow of the plurality of data packets.

13. The method of claim 9, further comprises:
fragmenting, by the PL unit, each of the plurality of data packets into a predefined number of Advanced extensible Interface (AXI) burst fragments, after appending the data packet header to each of the plurality of data packets; and
bursting, by the PL unit, the AXI burst fragments into the DDR memory unit.

14. The method of claim 9, wherein the predefined size of the memory region reserved on the DDR memory unit is determined based on bandwidth of a communication channel established between the RU and the DU.

15. The method of claim 9, wherein the trigger command comprises at least one of a total number of data packets to be captured by the PL unit, a capture duration and an indication to capture at least one of downlink data packets and uplink data packets.

16. The method of claim 9, wherein the plurality of data packets includes one or more uplink data packets and one or more downlink data packets, wherein the one or more uplink data packets are stored in a first region of the DDR memory unit, which is different from a second region of the DDR memory unit used to store the one or more downlink data packets.

17. The method of claim 9, wherein the PCAP data file is generated by merging each of the one or more uplink data packets and each of the one or more downlink data packets according to the timestamp of each of the one or more uplink data packets and each of the one or more downlink data packets.

18. A non-transitory computer readable storage medium including instructions stored thereon, that when processed by at least one processor, cause a Programmable Logic (PL) unit of a Radio Unit (RU) to perform operations comprising:
capturing each of a plurality of data packets exchanged between the RU and a Distributed Unit (DU) connected to the RU, upon receiving a trigger command from a control unit of the RU;
determining a timestamp and a data size of each of the plurality of data packets;
generating a data packet header corresponding to each of the plurality of data packets, wherein the data packet header comprises the timestamp and the data size of each of the plurality of data packets;
appending the data packet header to each of the plurality of data packets;
transmitting each of the plurality of data packets, appended with the data packet header, to a Double Data Rate (DDR) memory unit of the RU; and
generating a Packet Capture (PCAP) data file corresponding to the plurality of data packets by converting each of the plurality of data packets into a PCAP format for validating the plurality of data packets exchanged between the RU and the DU.

19. The storage medium of claim 18, wherein the instructions further cause the PL unit to perform operations comprising:
comparing a packet size of each of the plurality of data packets with a predefined packet size, after appending the data packet header to each of the plurality of data packets;
identifying one or more data packets, among the plurality of data packets, whose packet size is less than the predefined packet size; and
appending a plurality of random data bits to each of the one or more identified data packets to match the packet size of each of the one or more data packets with the predefined packet size.

20. The storage medium of claim 18, wherein the instructions further cause the PL unit to perform operations comprising:
fragmenting each of the plurality of data packets into a predefined number of Advanced extensible Interface (AXI) burst fragments, after appending the data packet header to each of the plurality of data packets; and
bursting, by the PL unit, the AXI burst fragments into the DDR memory unit.
